(19) United States
(12) Patent Application Publication
(10) Pub. No.: US 2010/0065644 A1
(43) Pub. Date: Mar. 18, 2010

(54) Device for Receiving a Card

(76) Inventor: Harald Trampert, Villingen-Schwenningen (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/307,892

(22) PCT Filed: Jul. 5, 2007
(86) PCT No.: PCT/EP07/56829

§ 371 Date: Feb. 17, 2009

(51) Int. Cl. G06K 13/08

(52) U.S. Cl. 235/480

(57) ABSTRACT

The invention relates to a device for receiving a card with a housing. Said housing has a horizontal, slot-shaped receiving opening for introducing a card into a receiving slot in the interior of the card receiving device. Additionally, a closure is provided for closing the receiving opening, the closure having a closure element with a seal, which extends in the longitudinal direction of the receiving opening and which is movable against an elastic force, at right angles to the plane of the receiving slot, from a closed position blocking off the receiving opening into a release position releasing the receiving opening. The closure element can be lifted in a guide of the housing at right angles to the plane of the receiving slot from the closed position into the release position, and is fitted with a sealing lip, extending over the length of the receiving opening, made from an elastic plastic, which in the closed position is in contact with the lower slot wall of the receiving slot.

The invention relates to a device for receiving a card, in particular for a tachograph in a motor vehicle, comprising a housing, which has a horizontal, slot-like receiving opening for inserting a card, in particular a chip card, in a receiving slot in the interior of the device for receiving a card, and comprising a closure for closing the receiving opening, the closure comprising a closure element with a seal, which extends in the longitudinal direction of the receiving opening and which may be moved counter to a spring force at right angles to the plane of the receiving slot from a closed position covering the receiving opening into an open position exposing the receiving opening.

In such a device for receiving a card, it is known to configure the upper wall of the receiving slot rigidly and the lower wall of the receiving slot as a spring arm extending in the direction of insertion. One end of the spring arm bears a seal which is pretensioned by the spring arm against the upper wall of the receiving slot and forms the receiving opening between itself and the upper wall of the receiving slot.

When the card is inserted, said receiving opening is opened by a corresponding downward pivoting of the spring arm.

The long length of the spring arm projecting into the interior of the housing of the device for receiving a card requires a large overall depth of said device.

Moreover, the pretensioning force, with which the spring arm urges the seal in the closing direction, has to be high as not only a closing of the receiving opening has to be ensured but also the weight of the seal and the spring arm has to be lifted.

It is, therefore, the object of the invention to provide a device for receiving a card of the aforementioned type which with a simple design has a small space requirement and avoids the penetration of contaminants into the interior of the device for receiving the card.

This object is achieved according to the invention by the closure element being guided in a liftable manner in a guide of the housing at right angles to the plane of the receiving slot from the closed position into the open position, and being provided with a sealing lip made of a resilient plastics material extending over the length of the receiving opening, which in the closed position bears against the lower slot wall of the receiving slot.

Thus the region of the closure is configured to be compact and only requires a small amount of constructional space.

This object is also achieved because the spring force required for the secure closing of the closure may be designed to be low.

The sealing lip made of a resilient plastics material permits an efficient removal of dirt and moisture from the card, so that such contaminants do not enter the device for receiving a card. This is also the case when the card is not inserted or partially inserted in the device for receiving a card.

The closure element is preferably urged by a spring into the closed position, which rests with its one end on the housing and with its other end bears with pretensioning against the side of the closure element remote from the sealing lip.

The spring may be a helical compression spring.

A particularly flat construction is achieved if the spring is a spring arm, in particular a leaf spring, which is fastened with its one end region to the housing and with its other end region bears with pretensioning in the closure element.

To avoid friction losses, the spring arm may bear against the closure element with linear contact or point contact so that it is possible to minimize the required spring force.

For simple and secure guiding, the closure element may have at its lateral ends guide projections projecting in opposing directions, which project into guide grooves of the housing extending at right angles to the plane of the receiving slot.

A potential for simple manufacture and assembly is achieved by the sealing lip being injection-molded onto the closure element, resulting in an additional reduction in the number of components when the closure element and the sealing lip form a two-component plastics injection-molded part.

For the secure insertion of the card into the receiving opening, the closure element may have on its insertion side a lead-in chamfer, which extends over the width of the receiving opening and is inclined in the direction of insertion of the card toward the sealing lip.

In order to free both the card surface and the card side edges from contaminants, with a requirement for a small number of components and a small amount of constructional space, and also with a partially inserted card to prevent the penetration of contaminants into the inside of the device for receiving a card, the closure element may comprise a U-shaped carrier, the sealing lip being arranged in a U-shaped manner on the inner periphery thereof.

So that with a partially inserted card the side edges are completely and reliably sealed, the free ends of the arms of the U-shaped carrier in the closed position may be sunk into corresponding recesses of the housing.

So that moisture removed by the sealing lips may be expelled, preferably in the direction of insertion of the card, the housing has one or more moisture removal apertures in front of the receiving opening leading to the outside of the housing.

In the direction of insertion of the card, a front cover may be arranged in front of the housing which has an insertion slot which opposes the receiving opening in one plane and which is of the same width as the receiving opening.

One embodiment of the invention is shown in the drawings and is disclosed in more detail hereinafter, in which:

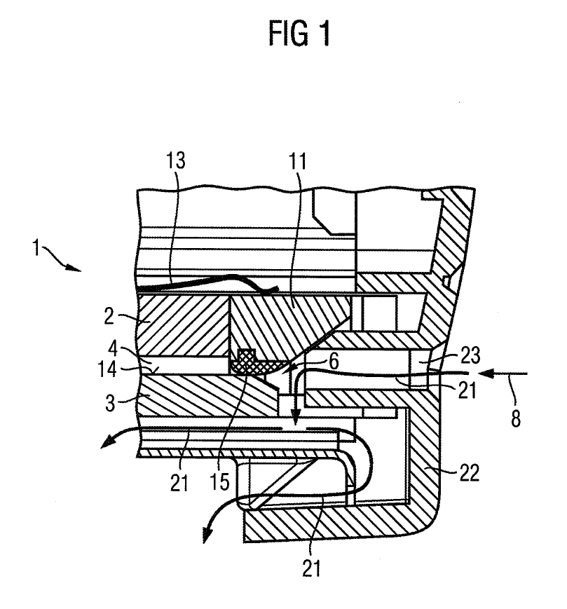

FIG. 1 shows a cross section of a detail in the card insertion region of a device for receiving a card in the closed state;

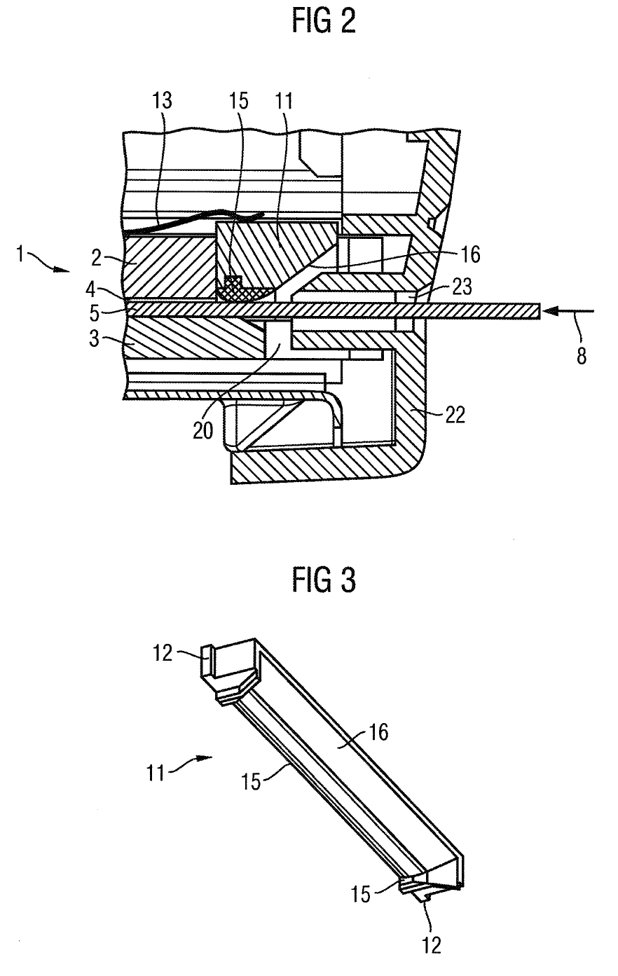

FIG. 2 shows the detail according to FIG. 1 with a partially inserted card;

FIG. 3 shows a closure element of the device for receiving a card according to FIG. 1 in perspective view;

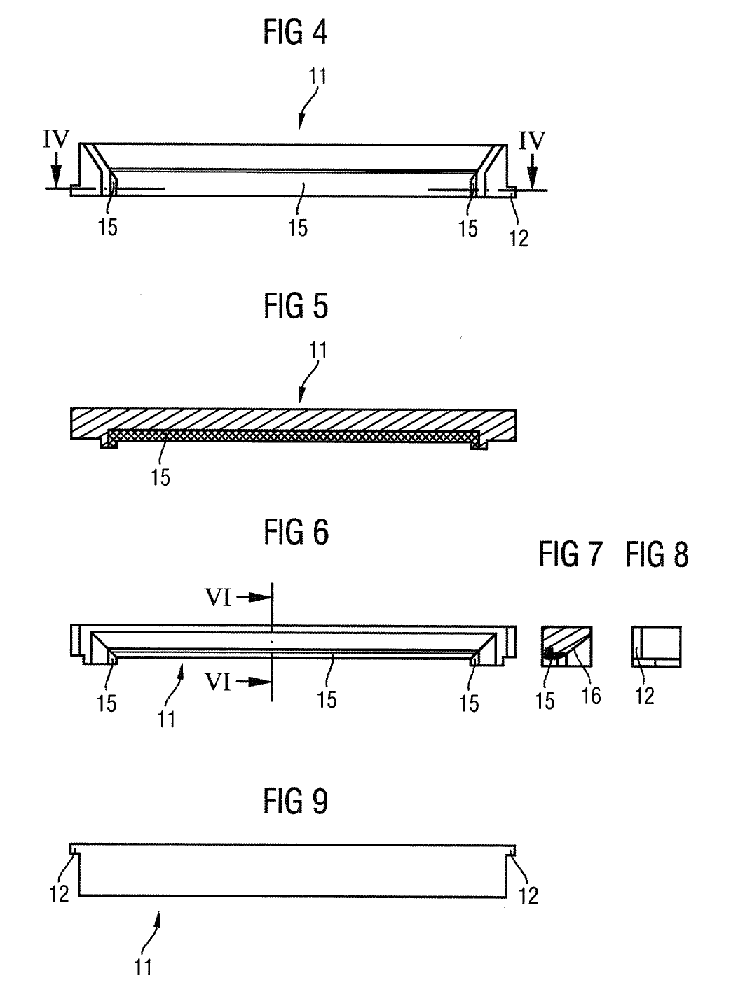

FIG. 4 shows the closure element according to FIG. 3 in a view from below;

FIG. 5 shows a section of the closure element according to FIG. 3 along a line IV-IV in FIG. 4;

FIG. 6 shows the closure element according to FIG. 3 in side view;

FIG. 7 shows a section of the closure element according to FIG. 3 along a line VI-VI in FIG. 6;

FIG. 8 shows a front view of the closure element according to FIG. 3;

FIG. 9 shows the closure element according to FIG. 3 in plan view;

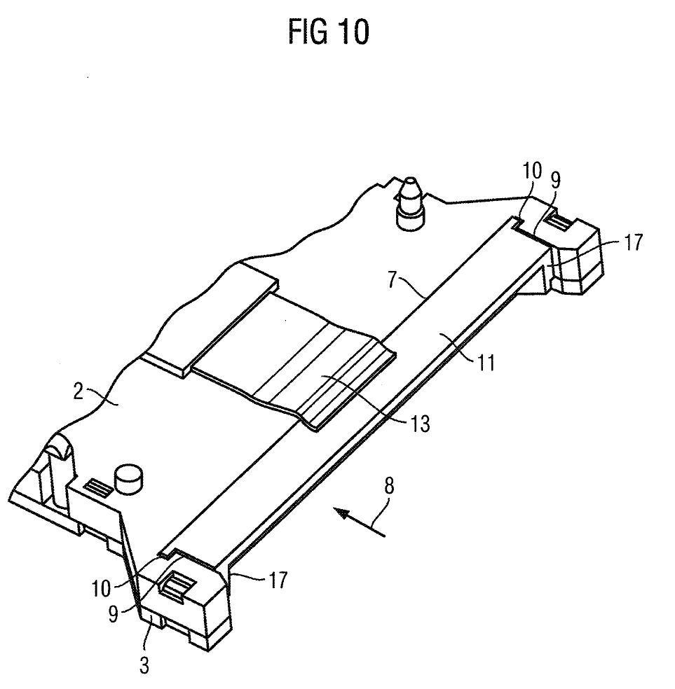

FIG. 10 shows a perspective plan view of a detail in the card insertion region of the housing and closure element of the device for inserting a card according to FIG. 1 in the closed state;

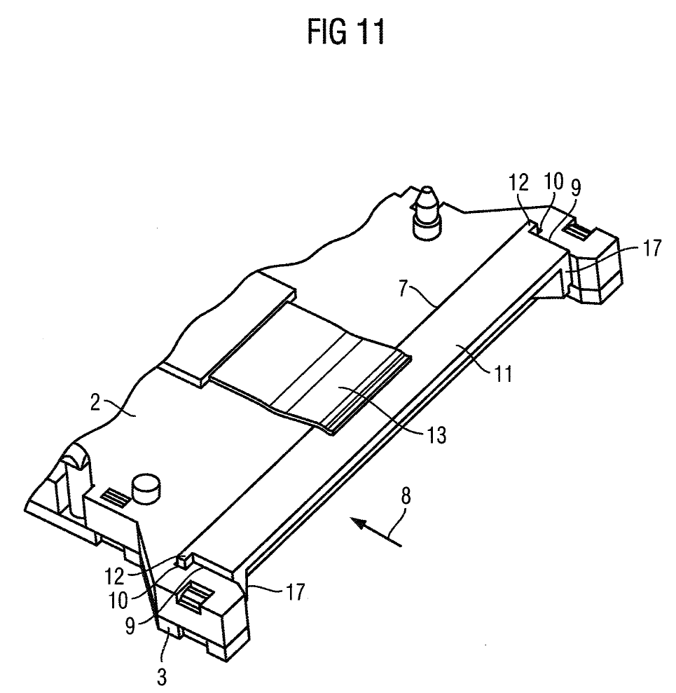

FIG. 11 shows a perspective plan view of a detail in the card insertion region of the housing and closure element of the device for inserting a card according to FIG. 1 in the open state;

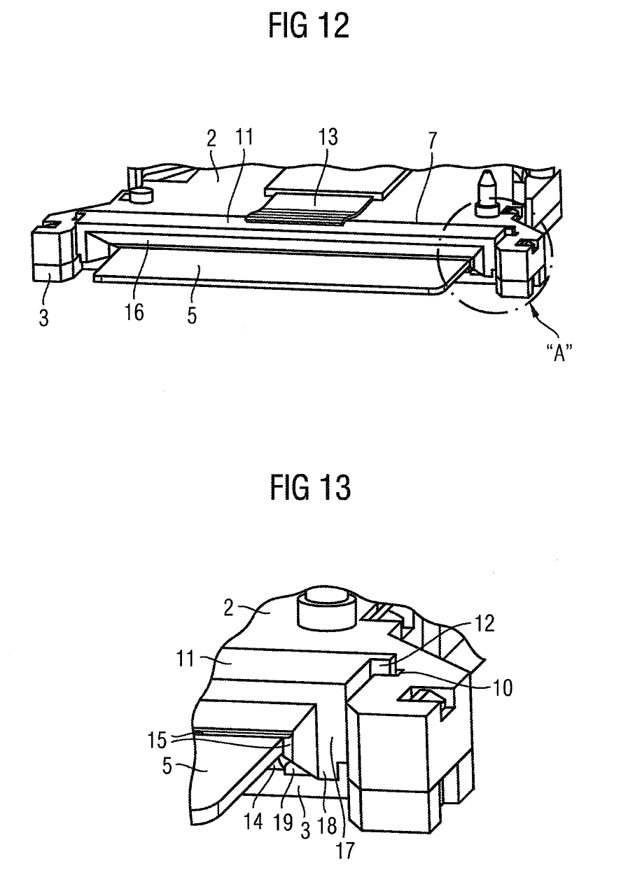

FIG. 12 shows a perspective front view of the housing and closure element of the device for inserting a card according to FIG. 1 with the partially inserted card;

FIG. 13 shows an enlarged view of the detail “A” of FIG. 12;

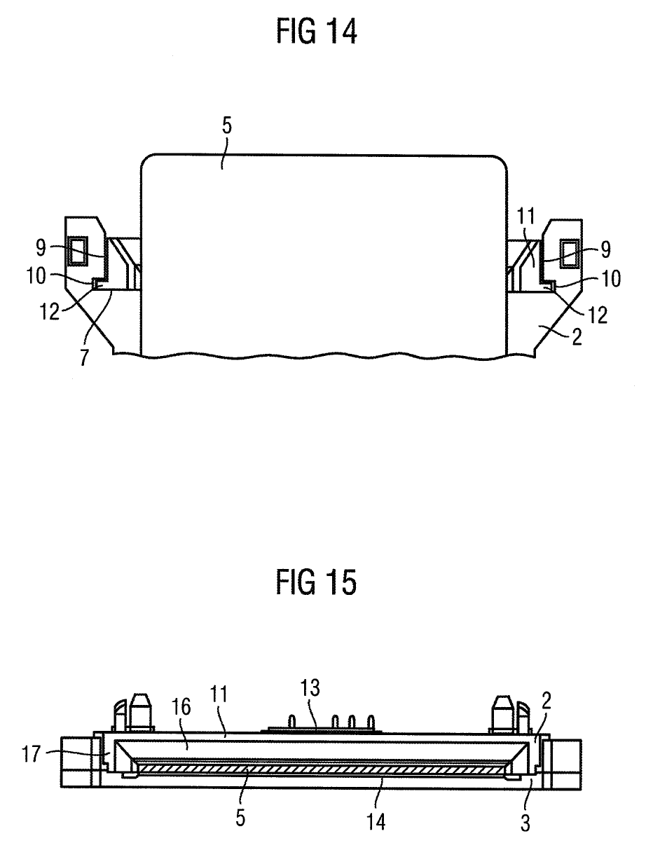

FIG. 14 shows a view from below of a detail in the card insertion region of the upper part of the housing and the closure element with the partially inserted card and

FIG. 15 shows a front view of the housing and closure element of the device for inserting a card according to FIG. 1 with a partially inserted card.

The device for receiving a card which is shown has a housing 1 which consists of a plate-like upper housing part 2 and a plate-like lower housing part 2, which are connected to one another.

Between the upper housing part 2 and the lower housing part 3 a horizontal receiving slot 4 is formed for receiving a card 5 configured as a chip card.

The end of the receiving slot 4 on the insertion side forms a slot-like receiving opening 6 for inserting the card 5 into the receiving slot 4 from outside.

In the region of the receiving opening 6, in the upper housing part 2, a recess 7 of rectangular cross section extending transversely to the direction of insertion 8 of the card 5 is configured continuously transversely to the plane of the receiving slot 4. On the short side walls 9 of the recess 7 which extend in the direction of insertion 8, one respective guide groove 10 is configured which extends at right angles to the plane of the receiving slot 4.

In the recess 7 a closure element 11 corresponding to the external contour is arranged displaceably guided at right angles to the plane of the receiving slot 4, which at its lateral ends has guide projections 12 projecting in opposing directions and projecting into the guide grooves 10.

A leaf spring 13 fixedly arranged with its one end on the upper housing part 2 extends in the direction of insertion 8 and bears with pretensioning with its free end region with linear contact on the upper face of the closure element 11 and urges said closure element to bear with its lower region on the lower wall 14 of the receiving slot 4 formed by the lower housing part 3.

The closure element 11 has on its side facing the wall 14, along the end facing the housing interior, a sealing lip 15 made of a resilient plastics extending over the width of the receiving opening 6.

The closure element 11 and sealing lip 15 are configured as a two-component plastics injection-molded part.

On its insertion side the closure element 11 has a lead-in chamfer 16 which extends over the width of the receiving opening 6 and is inclined in the direction of insertion 8 of the card 5 toward the sealing lip 15.

In the region of the sealing lip 15, the closure element is configured in a U-shaped manner with arms 17 oriented toward the wall 14, the sealing lip 15 also extending with its ends along the arms 17, so that it is also configured in a U-shaped manner.

The free ends 18 of the arms 17, when the sealing lip 15 bears against the wall 14, may penetrate corresponding recesses 19 in the lower housing part 3.

In the direction of insertion 8 in front of the lower housing part 3 and thus in front of the receiving opening 6, a moisture removal aperture 20 is configured, through which moisture may be discharged to the outside corresponding to the arrows 21 illustrated in FIG. 1.

In the direction of insertion 8 of the card 5 in front of the housing 1, a front cover 22 is arranged connected to the housing, which has an insertion slot 23 opposing the receiving opening 6 in one plane, which is of the same width as the receiving opening 6.

1.-12. (canceled)

13. A device for receiving a card in a tachograph in a motor vehicle, comprising:
a housing having a horizontal slot-like opening configured to receive a chip card and a guide;
a receiving slot in the interior of the housing configured to receive the chip card, the receiving slot having an upper wall and a lower wall with respect to a plane of the receiving slot; and
a closure for closing the receiving slot, the closure comprising:
a closure element that extends in a longitudinal direction of the receiving opening configured for movement counter to a spring force at right angles to the plane of the receiving slot from a closed position covering the receiving slot into an open position exposing the receiving slot;
a resilient plastic sealing lip extending over the length of the receiving slot, which in the closed position bears against the lower wall of the receiving slot; and
guide projections projecting in opposing directions from the lateral ends of the closure configured to project into the housing guide,
wherein the closure element is liftably guided in the guide of the housing in a direction substantially perpendicular to the plane of the receiving slot from the closed position into the open position.

14. The device for receiving a card according to claim 13, further comprising a spring configured to urge the closure element into the closed position, the spring having a first end that rests on the housing and a second end that bears with pretensioning force against a side of the closure element remote from resilient plastic sealing lip.

15. The device for receiving a card according to claim 14, wherein the spring is a spring arm.

16. The device for receiving a card according to claim 15, wherein the spring arm bears against the closure element with one of a linear contact and a point contact.

17. The device for receiving a card according to claim 13, wherein the sealing lip is injection-molded onto the closure element.

18. The device for receiving a card according to claim 17, wherein the closure element and the sealing lip are formed as a two-component plastic injection-molded part.

19. The device for receiving a card according to claim 13, wherein the closure element has a lead-in chamfer on its insertion side inclined in the direction of insertion of the card, which extends over the width of the receiving opening.

20. The device for receiving a card according to claim 13, wherein the closure element has a U-shaped carrier, the sealing lip being arranged in the U-shaped carrier in the inner periphery thereof.

21. The device for receiving a card according to claim 20, wherein free ends of arms forming the U-shaped are configured to mate with corresponding recesses of the housing when the closure is in the closed position.

22. The device for receiving a card according to claim 13, wherein in a direction of insertion of the card, the housing has at least one moisture removal aperture in front of the receiving slot, leading to an outside of the housing.

23. The device for receiving a card according to claim 13, wherein a front cover is arranged in front of the housing in a direction of insertion of the card, having an insertion slot which opposes the receiving slot in a plane, the insertion slot being the same width as the receiving slot.

24. The device for receiving a card according to claim 15, wherein the spring is a leaf spring.
